(19) United States
(12) Patent Application Publication
(10) Pub. No.: US 2006/0132670 A1
(43) Pub. Date: Jun. 22, 2006

(54) Light-reflecting member, backlight assembly having the light-reflecting member, and method of manufacturing the light-reflecting member

(76) Inventors: Jin-Sung Choi, Yongin-si (KR); Jheen-Hyeok Park, Seongnam-si (KR); Jeong-Hwan Lee, Suwon-si (KR); Jin-Mi Jung, Seoul (KR)

Correspondence Address: MCGUIREWOODS, LLP, 1750 TYSONS BLVD, SUITE 1800, MCLEAN, VA, 22102, US

(21) Appl. No.: 11/274,221

(22) Filed: Nov. 16, 2005

(30) Foreign Application Priority Data
Nov. 17, 2004 (KR) 2004-94319

(51) Int. Cl. G02F 1/1335

(52) U.S. Cl. 349/62

(57) ABSTRACT

A light-reflecting member includes a resin composition having a porous structure. The porous structure may be formed by infiltrating/exhausting a super critical fluid into/from a resin composition. A resin composition is mixed and heated at a temperature no less than about a glass transition temperature. A super critical fluid is infiltrated into the resin composition at a pressure no less than about a critical pressure. The super critical fluid is released from the resin composition by decompressing the resin composition to an atmospheric pressure to form a porous structure.

### CROSS REFERENCE TO RELATED APPLICATION

This application claims priority to and the benefit of Korean Patent Application No. 2004-94319, filed on Nov. 17, 2004, which is hereby incorporated by reference for all purposes as if fully set forth herein.

### BACKGROUND OF THE INVENTION

1. Field of the Invention

The present invention relates to a light-reflecting member, a backlight assembly having the light-reflecting member, and a method of manufacturing the light-reflecting member. In particular, the present invention relates to a light-reflecting member with an improved reflexibility, a backlight assembly having the light-reflecting member, and a method of manufacturing the light-reflecting member.

2. Description of the Related Art

In general, since a liquid crystal display (LCD) apparatus is not self emissive, a backlight assembly is used. The backlight assembly operates as a part of the LCD apparatus and affects brightness; e.g., increase/decrease a luminance level, and an external appearance of the LCD apparatus. The backlight assembly includes a lamp and a reflection film arranged adjacent to the lamp to reflect a light coming from the lamp.

FIG. 1 is a chart showing a conventional diffusion reflective type and a specular reflective type light-reflecting member.

Referring to FIG. 1, a reflection film manufactured by Toray Co., Japan includes an upper layer, a lower layer, and a middle layer interposed between the upper and lower layers. The middle layer includes micro-bubbles formed by mixing a polyester film with a foaming chemical. The upper and lower layers include calcium carbonate. A reflection film manufactured by Teijin Co. Japan, or Dupont Co. U.S., includes upper and lower layers having barium sulfate, and a middle layer including a foamed material. A reflection film manufactured by Mitsui Chemical Inc. Japan includes a coating layer having silver to specularly reflect a light.

However, since the conventional reflection films include either multi-layers or a silver material, manufacturing the conventional reflection films is inefficient and/or costly.

### SUMMARY OF THE INVENTION

The present invention provides a light-reflecting member having improved light-reflecting efficiency and reflexibility.

Additional features of the invention will be set forth in the description which follows, and in part will be apparent from the description, or may be learned by practice of the invention.

The present invention provides a light-reflecting member, including a resin composition having a porous structure, the porous structure being formed by an infiltration of a super critical fluid into a resin composition, and a subsequent release of the infiltrated super critical fluid from the resin composition.

The present invention also provides a backlight assembly, including a light-emitting unit; and a backlight unit positioned under the light-emitting unit, the backlight unit including a light-reflecting member that includes a resin composition having a porous structure to reflect a light emitted or coming from the light-emitting unit, the porous structure being formed by infiltrating a super critical fluid into a resin composition and subsequently releasing the infiltrated super critical fluid from the resin composition.

The present invention also provides a liquid crystal display apparatus, including a light-emitting unit; a light-reflecting member positioned under the light-emitting unit, the light-reflecting member including a resin composition having a porous structure to reflect a light coming from the light-emitting unit, the porous structure being formed by infiltrating a super critical fluid into a resin composition and releasing the infiltrated super critical fluid from the resin composition; an optical member diffusing the light coming from the light-emitting unit; and a display unit arranged over the optical member to display an image using a light passing through the optical member.

The present invention also provides a method for forming a porous structure, including infiltrating a super critical fluid into a resin composition; and releasing the super critical fluid from the resin composition.

The present invention also provides a method of manufacturing a light-reflecting member, including heating and mixing a resin composition at a temperature that is equal to or greater than about a glass transition temperature; infiltrating a super critical fluid into the resin composition under a pressure that is equal to or greater than about a critical pressure; and releasing the super critical fluid from the resin composition by decompressing the resin composition to an atmospheric pressure to form a porous structure.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a chart showing a conventional diffusion reflective type reflecting member and a specular type light-reflecting member.

FIG. 2 is an exploded perspective view showing an LCD apparatus according to an embodiment of the invention.

FIG. 3 is an exploded perspective view showing an LCD apparatus according to an embodiment of the invention.

FIG. 4 is a graph showing phase equilibrium of carbon dioxide.

FIG. 5 is a block diagram showing a liquid fluid, a super critical fluid and a gaseous fluid.

FIG. 6 is a picture showing a scanning electron microscope (SEM) image of a light-reflecting member according to an embodiment of the invention.

FIG. 7 is a perspective view showing morphology variations of a film that is treated with super critical carbon dioxide.

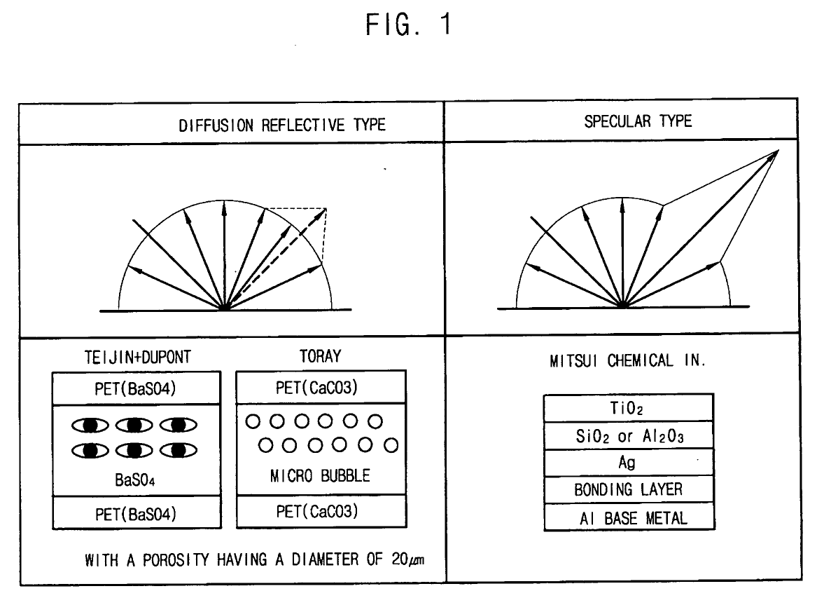

### DESCRIPTION OF THE ILLUSTRATED EMBODIMENTS

The present invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough, and will fully convey the scope of the invention to those skilled in the art. In the drawings, the size and relative sizes of layers and regions may be exaggerated for clarity.

It will be understood that when an element or layer is referred to as being “on”, “connected to” or “coupled to” another element or layer, the element may be directly on, connected or coupled to/with the other element or layer or intervening elements or layers may be present. In contrast, when an element is referred to as being “directly on,” “directly connected to” or “directly coupled to” another element or layer, there are no intervening elements or layers present. Like numbers refer to like elements throughout. As used herein, the term “and/or” includes any and all combinations of one or more of the associated listed items.

It will be understood that, although the terms first, second, etc. may be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the present invention.

Spatially relative terms, such as “beneath”, “below”, “lower”, “above”, “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, when the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “includes” and/or “including”, when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

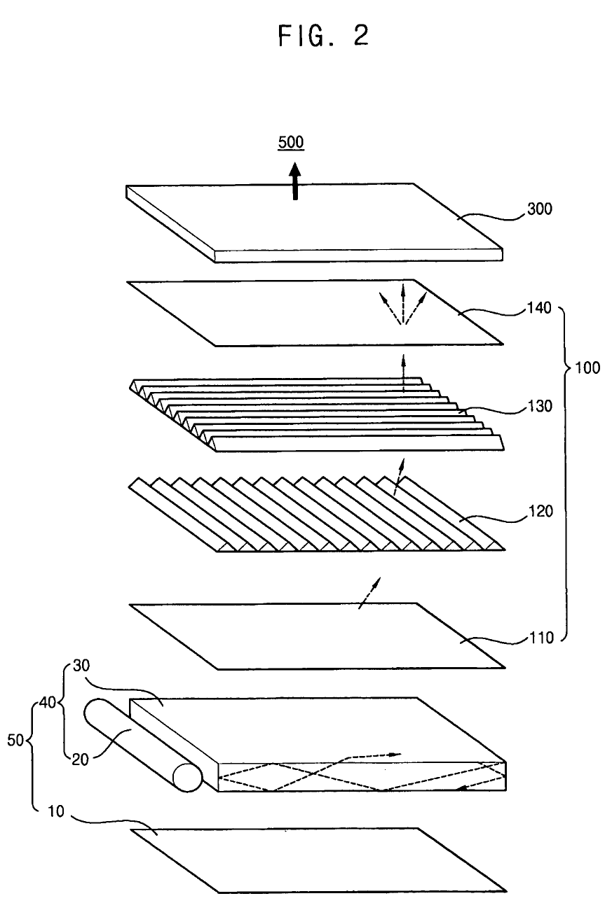

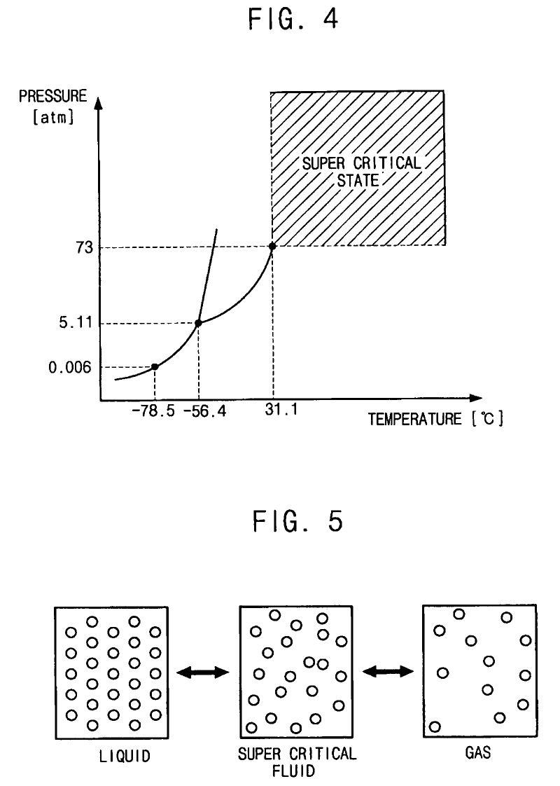

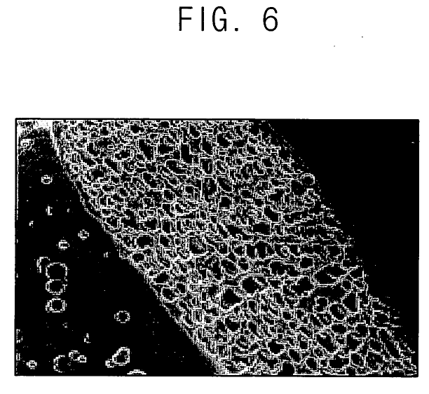

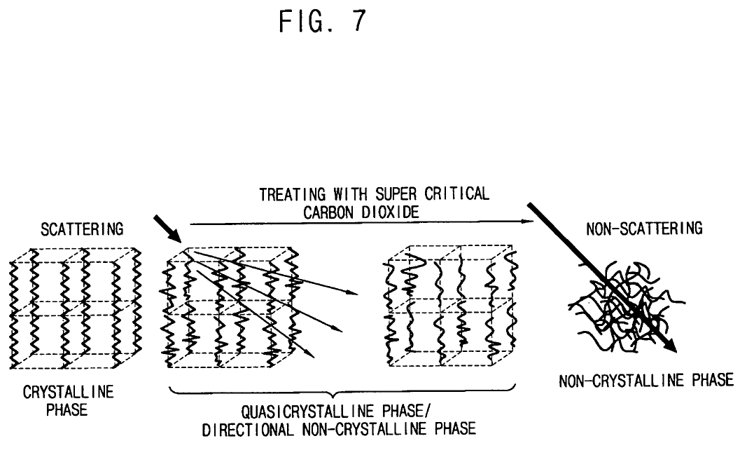

FIG. 2 is an exploded perspective view showing an LCD apparatus according to an embodiment of the invention. FIG. 4 is a graph showing phase equilibrium of carbon dioxide. FIG. 5 is a block diagram showing a liquid fluid, a fluid having a super-critical state and a gaseous fluid. FIG. 6 is a picture illustrating a scanning electron microscope (SEM) image of a light-reflecting member according to an embodiment of the invention. FIG. 7 is a perspective view showing morphology variations of a film that is treated with carbon dioxide in a super-critical state.

Referring to FIG. 2, an LCD apparatus 500 includes a backlight assembly 50, an optical member 100 and a display unit 300.

The backlight assembly 50 includes a light-emitting unit 40 that includes a lamp 20 and a light-guiding plate 30, and a light-reflecting member 10. The lamp 20 may be located at one side or both sides of the light-guiding plate 30.

A first light emitted from the lamp 20 is incident upon the light-guiding plate 30. The light-guiding plate 30 converts the first light into a second planar light. The light-guiding plate 30 may be a substantially rectangular parallel pipe-like shape that has four sidewalls, a light-exiting face connected with the sidewalls, and a light-reflecting face facing the light-exiting face.

The light-reflecting member 10 may be placed under the light-guiding plate 30. The light-reflecting member 10 reflects a light leaked from the light-reflecting face of the light-guiding plate 30 to the display unit 300.

The light-reflecting member 10 includes a resin composition having a porous structure. The resin composition is preferably a foam. The resin may include a polycarbonate-based polymer, a polysulfone-based polymer, a polyacrylate-based polymer, a polystyrene-based polymer, a polyvinylchloride-based polymer, a polyvinylalchol-based polymer, a polynorbonene-based polymer, a polyester-based polymer such as polyethylene terephthalate or polyethylene naphthalate, etc. These polymers may be used alone or in a combination thereof to improve a physical property of the resin.

The porous structure of the light-reflecting member 10 improves its reflexibility. The porous structure may be formed by a manner such that a super critical fluid is infiltrated into a resin composition and then exhausted from the resin composition. The super critical fluid may include carbon dioxide, nitrogen, oxygen, hydrogen, helium, etc., alone or in a combination thereof.

Super critical carbon dioxide has good infiltration and solubility. Thus, solubility, a viscosity, a coefficient of diffusion and a thermal conductivity of super critical carbon dioxide may be readily adjusted by controlling a temperature and a pressure. Super critical carbon dioxide has no adverse effect, i.e., is innoxious, on the human body and does not contaminate environment, i.e., eco-friendly. Further, since super critical carbon dioxide is infiltrated or settles into gaps between high molecules in a film, the film appearance may not change.

A temperature and a pressure at a critical state in which a liquid state and a gaseous state are not discriminated from each other are known as a critical temperature and a critical pressure, respectively. A gas having a temperature that is above critical temperature may not be liquefied, although a pressure may be continuously applied to the gas. Thus, the super critical fluid may be defined as a fluid that is greater than or equal to the critical temperature and the critical pressure. A property of a solvent may be determined by reciprocal reactions between molecules in the solvent that vary in accordance with kinds of the molecules and distances between the molecules. Since a liquid solvent is an incompressible fluid, the distances between the molecules may not be altered. As a result, the property of the liquid solvent may not change much. On the contrary, since the super critical fluid has a density that continuously changes from a low density of an ideal gas to a high density of a liquid, an equilibrium property of the super critical fluid such as solubility, an entrainer effect, etc., and a transmission property of the super critical fluid such as a viscosity, a coefficient of diffusion, a thermal conductivity, etc., may be readily changed. Thus, when the super critical fluid is used for reaction and dissociation processes, desired properties of the super critical fluid may be obtained by varying a temperature and/or a pressure.

Referring to FIG. 4, carbon dioxide has a critical temperature of about 31.1° C. and a critical pressure of about 73 atm. The super critical fluid is shown as a hatched region in FIG. 4 where carbon dioxide has a temperature and a pressure that is greater than or equal to a critical temperature and a pressure, respectively.

Referring to FIG. 5, the density of molecules in the super critical fluid is less than that of a liquid state and greater than that of a gaseous state.

Here, when the porous structure has a plurality of porosities having a diameter greater than about 10 μm, the reflexibility and strength of the light-reflecting member 10 decreases. Thus, each of the porosities of the porous structure preferably has a diameter of no more than about 10 μm. The porosities refer to the space provided between the molecules in the porous structure.

Referring to FIG. 6, the light-reflecting member 10 has a cross section having a plurality of porosities. A resin in the light-reflecting member 10 has a non-crystalline phase. To form the porous structure, when super critical carbon dioxide is infiltrated or settled into the resin, super critical carbon dioxide converts a crystalline structure such as a crystalline phase, a quasicrystalline phase or a directional non-crystalline phase into a non-crystalline structure.

Also, the porosities are provided at a surface of the light-reflecting member 10 and/or inside of the light-reflecting member 10 when the super critical fluid is released from the light-reflecting member 10. The surface of the light-reflecting member 10 may have an irregularly shaped indented structure. When the light-reflecting member 10 is not planarized, the irregularly shaped indented structure may remain at the surface of the light-reflecting member 10.

FIG. 7 shows morphology variations of the structure in the light-reflecting member 10 that is treated with super critical carbon dioxide. With reference to FIG. 7, when the light-reflecting member 10 is treated with super critical carbon dioxide, the structure of the light-reflecting member 10 changes from a crystalline phase to a non-crystalline phase through a quasicrystalline phase/directional non-crystalline phase.

The light-reflecting member 10 having the non-crystalline phase may reduce scattering of the light so that a transmissitivity of the light-reflecting member 10 improves, thereby suppressing or reducing a loss of the light in the light-reflecting member 10. Also, the light-reflecting member 10 may have an improved mechanical property. Non-reacted monomers may be removed from the light-reflecting member 10 due to the infiltration of super critical carbon dioxide.

A method of manufacturing the light-reflecting member 10 is described below.

A resin composition is heated and mixed at a temperature that is greater than or equal to about a glass transition temperature. The super critical fluid infiltrates the resin composition when a pressure that is greater than or equal to about a critical pressure is applied to the resin composition. The super critical fluid is released from the resin composition by decompressing the resin composition to about an atmospheric pressure to form the light-reflecting member 10 having the porous structure.

In particular, for example, super critical carbon dioxide infiltrates or enters the resin composition under a pressure of no less than about the critical pressure, preferably no less than about 15 MPa, while the resin composition is mixed in an extruding machine. When the temperature is lower than about the glass transition temperature, super critical carbon dioxide may not be infiltrated into the resin composition, which reduces a foaming effect. However, when the temperature is higher than the glass transition temperature by about 30° C., the light-reflecting member 10 may have an excessively foamed structure. Thus, super critical carbon dioxide is infiltrated into the resin composition at a temperature of about 30° C. above than the glass transition temperature. There is no restriction regarding the time required for the infiltration of the super critical carbon dioxide.

After completing the infiltration of super critical carbon dioxide, the resin composition is decompressed. The decompression may be performed by force, e.g., by exposing the resin composition to the atmospheric pressure, or by other decompression methods. Super critical carbon dioxide is released from the resin composition through decompression to form the porous structure in the light-reflecting member 10. Simultaneously, the resin composition cools while decompressing so that the crystalline structure of the resin composition converts into the non-crystalline structure.

Preparing Light-Reflecting Members

### EXAMPLE 1

About 20 percent by weight of polyethylene terephthalate and about 80 percent by weight of polycarbonate were loaded into an extruding machine that included two shafts having a diameter of about 35 mm. The extruding machine operated at a temperature of about 280° C. at a speed of about 3,000 rpm to obtain a pellet. The pellet was pressed in a pressing machine at a temperature of about 280° C. under a pressure of about 100 kg/cm² to obtain a film having a size of about 150 mm×300 μm. The film was loaded into an autoclave having an internal dimension of about 40 mm×150 mm that was used as a super critical foaming machine. A super critical carbon dioxide fluid was then introduced into the autoclave at about a room temperature. A temperature and a pressure in the autoclave were increased to about 140° C. and about 15 Mpa, respectively. The temperature and the pressure in the autoclave were then decreased to about 25° C. and about an atmospheric pressure, respectively, to form a light-reflecting member having a porous structure.

### COMPARATIVE EXAMPLE 1

A reflection film manufactured by Toray Co. Japan was used. The reflection film included an upper layer, a lower layer and a middle layer interposed between the upper layer and the lower layer. The middle layer included micro-bubbles formed by mixing a polyester film with a foaming chemical. The upper layer and the lower layer included calcium carbonate.

### COMPARATIVE EXAMPLE 2

A reflection film manufactured by Dupont Co. U.S., was used. The reflection film included an upper layer and a lower layer including barium sulfate, and a middle layer including a foamed material.

Measuring Luminance

After the light-reflection member in Example 1 and the reflection films in Comparative Examples 1 and 2 were provided to a backlight assembly, each of luminances of the light-reflection member and the reflection films was measured nine times using a BM 7 (model name: LTA70WP). Here, a voltage of 12V and a current of 2.6 A were applied to the backlight assembly. The measured luminances are shown in Table 1.

TABLE 1

Luminance (nit = cd/m²)

| | | Comparative | Comparative |
|---|---|---|---|
| | Example 1 | example 1 | example 2 |
| 1 | 5601 | 5256 | 5256 |
| 2 | 6016 | 5557 | 5634 |
| 3 | 5886 | 5455 | 5512 |
| 4 | 5784 | 5471 | 5443 |
| 5 | 6227 | 5735 | 5748 |
| 6 | 6174 | 5654 | 5699 |
| 7 | 5788 | 5406 | 5390 |
| 8 | 6612 | 5573 | 5662 |
| 9 | 6117 | 5561 | 5642 |
| Average | 5972.8 | 5518.7 | 5554 |

As shown in Table 1, it should be noted that the light-reflecting member of Example 1 has a higher luminance value than those of Comparative Examples 1 and 2.

Referring now to FIG. 2, the optical member 100 includes a first diffusion sheet 110, a first prism sheet 120, a second prism sheet 130, and a second diffusion sheet 140.

The first diffusion sheet 110 diffuses the light exiting the light-guiding plate 30 to the first prism sheet 120. The first and second prism sheets 120 and 130 are stacked on the first diffusion sheet 110. The first and second prism sheets 120 and 130 include protrusions having triangle columns to condense the light. The protrusions are arrayed in parallel on surfaces of the first and second prism sheets 120 and 130. In particular, as shown in FIG. 2, the protrusions of the first prism sheet 120 are substantially perpendicular to those of the second prism sheet 130. The second diffusion sheet 140 diffuses a light exiting the second prism sheet 130 to the display unit 300. It is understood that the invention is not limited to the optical member 100 having only two optical sheets. Further, it is understood that the optical sheets may have variously shaped and arranged columns.

The display unit 300 displays an image using the light emitted from the backlight assembly 50. The display unit panel 300 may be an LCD panel that includes a thin film transistor (TFT) substrate (not shown), an LC layer (not shown), a color filter substrate (not shown) and a driving module (not shown). The TFT substrate includes pixel electrodes arranged in a matrix pattern, TFTs applying driving voltages to the pixel electrodes, gate lines and data lines. The color filter substrate includes color filters facing the pixel electrodes, and common electrodes formed on the color filters. The LC layer is interposed between the TFT substrate and the color filter substrate. The driving module drives the LCD panel 300.

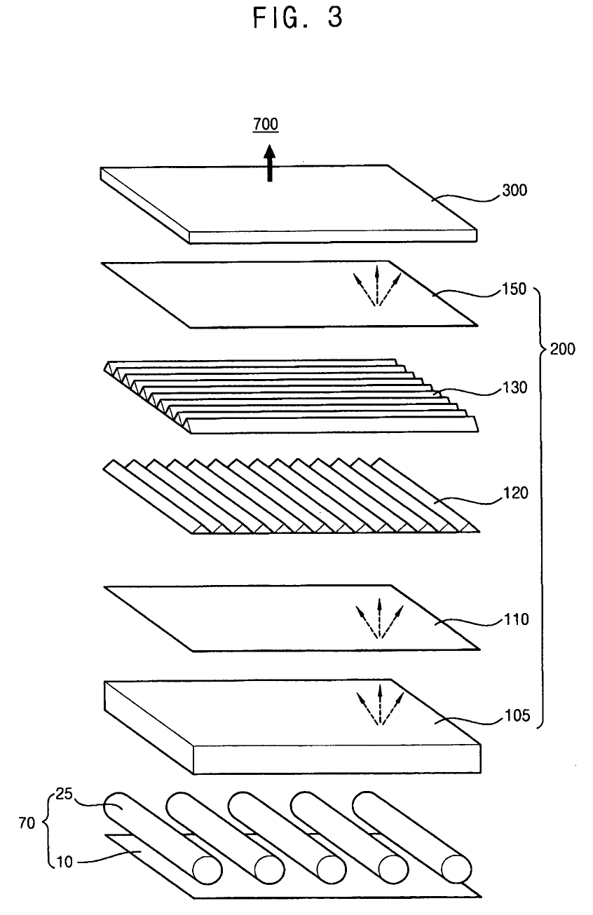

FIG. 3 is an exploded perspective view illustrating an LCD apparatus according to an embodiment of the invention.

The LCD apparatus 700 shown in FIG. 3 includes elements substantially identical to those of the LCD apparatus 500 shown in FIG. 2 except for a backlight assembly 70 and an optical member 200. Thus, the same reference numerals refer to the same elements and any further explanations with respect to the same elements will be omitted as necessary.

Referring to FIG. 3, the LCD apparatus 700 includes the backlight assembly 70, the optical member 200, and the display unit 300.

The LCD apparatus 700 may include a direct illumination type backlight assembly. The backlight assembly 70 may include a plurality of lamps 25 that are arranged substantially in parallel under the optical member 200. The light-reflecting member 10 is positioned under the lamps 25.

The optical member 200 includes a diffusion plate 105, a first diffusion sheet 110, a first prism sheet 120, a second prism sheet 130 and a dual brightness enhancement film (DBEF) 150.

The diffusion plate 105 may be formed of polymethylmethacrylate. The diffusion plate 105 is located over the lamps 25 to diffuse the light emitted from the lamps 25 to the first diffusion sheet 110. The first diffusion sheet 110, the first prism sheet 120, the second prism sheet 130 and the DBEF 150 are sequentially positioned, e.g., stacked together, over the diffusion plate 115.

According to the present invention, the porous structure of the light-reflecting member is formed by physical operations of the super critical fluid without using a foam and the light-reflecting member does not include an additional reflection layer to improve a reflection efficiency.

The light-reflecting member of the present invention may have a higher reflexibility than that of the conventional light-reflecting members.

Further, since the crystalline structure of the light-reflecting member is converted into the non-crystalline structure, the transmisstivity of the light-reflecting member may be improved, thereby suppressing or reducing the loss of the light in the light-reflecting member.

The temperature and the pressure of the super critical fluid are controlled so that the physical characteristics of the light-reflecting member may be adjusted.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A light-reflecting member, comprising:
a resin composition having a porous structure, the porous structure being formed by an infiltration of a super critical fluid into a resin composition, and a subsequent release of the infiltrated super critical fluid from the resin composition.

2. The light-reflecting member of claim 1, wherein the resin composition has porosities in the porous structure having a diameter of no greater than about 10 μm.

3. The light-reflecting member of claim 1, wherein the super critical fluid comprises carbon dioxide.

4. The light-reflecting member of claim 1, wherein the resin composition comprises at least one polymer selected from the group consisting of a polycarbonate-based polymer, a polysulfone-based polymer, a polyacrylate-based polymer, a polystyrene-based polymer, a polyvinylchloride-based polymer, a polyvinylalchol-based polymer, a polynorbonene-based polymer and a polyester-based polymer.

5. The light-reflecting member of claim 1, wherein the resin composition comprises a non-crystalline structure.

6. The light-reflecting member of claim 1, wherein the porous structure is formed at a surface of the resin composition.

7. The light-reflecting member of claim 1, wherein the resin composition has a non-uniformly shaped indented structure.

8. A backlight assembly comprising the light-reflecting member of claim 1 and a light-emitting unit, wherein the light-reflecting member reflects a light coming from the light-emitting unit, the porous structure being formed by infiltrating a super critical fluid into a resin composition and subsequently releasing the infiltrated super critical fluid from the resin composition.

9. The backlight assembly of claim 8, wherein the light-emitting unit comprises a plurality of lamps arranged substantially in parallel.

10. The backlight assembly of claim 8, wherein the light-emitting unit comprises:
a lamp; and
a light-guiding plate adjacent to the lamp to guide the light coming from the lamp.

11. The backlight assembly of claim 8, wherein the super critical fluid comprises carbon dioxide.

12. A liquid crystal display apparatus comprising the backlight assembly of claim 8 and further comprising:
an optical member diffusing the light coming from the light-emitting unit; and
a display unit arranged over the optical member to display an image using a light passing through the optical member.

13. The liquid crystal display apparatus of claim 12, wherein the super critical fluid comprises carbon dioxide.

14. A method of forming a porous structure, comprising:
infiltrating a super critical fluid into a resin composition; and
releasing the super critical fluid from the resin composition.

15. A method of manufacturing a light-reflecting member, comprising:
heating and mixing a resin composition at a temperature that is equal to or greater than about a glass transition temperature;
infiltrating a super critical fluid into the resin composition under a pressure that is equal to or greater than about a critical pressure; and
releasing the super critical fluid from the resin composition by decompressing the resin composition to an atmospheric pressure to form a porous structure.

16. The method of claim 15, wherein the super critical fluid comprises carbon dioxide.

17. The method of claim 15, wherein the resin composition comprises at least one polymer selected from the group consisting of a polycarbonate-based polymer, a polysulfone-based polymer, a polyacrylate-based polymer, a polystyrene-based polymer, a polyvinylchloride-based polymer, a polyvinylalchol-based polymer, a polynorbonene-based polymer and a polyester-based polymer.

18. The method of claim 15, wherein forming the porous structure comprises cooling the resin composition while simultaneously decompressing the resin composition.
